(19) United States
(12) Patent Application Publication
(10) Pub. No.: US 2026/0338481 A1
(43) Pub. Date: Oct. 29, 2026

(54) REACTOR EFFLUENT HEAT RECOVERY SYSTEM

(71) Applicant: Lummus Technology LLC, Bloomfield, NJ (US)

(72) Inventors: Richard John JIBB, Bloomfield, NJ (US); Roberto GROPPI, Bloomfield, NJ (US); Vincenzo Marco BRIGNONE, Bloomfield, NJ (US)

(21) Appl. No.: 18/997,455

(22) PCT Filed: Jul. 22, 2022
(86) PCT No.: PCT/US2022/037979

§ 371 Date: Jan. 21, 2025

(51) Int. Cl. F28D 7/02; B01J 19/00

(52) U.S. Cl. CPC F28D 7/02; B01J 19/0013; B01J 2219/00092; B01J 2219/00103

(57) ABSTRACT

A heat exchanger includes a shell with a longitudinal axis with a first portion of the shell on a first side of a plane through the shell and a second portion on a second side of the plane opposite to the first side. A first heat transfer surface is arranged in the first portion of the shell and a second heat transfer surface is arranged in the second portion of the shell. The first and second heat transfer surfaces may be coiled tube bundles with one of the coolant streams interfacing with the heat transfer surfaces being the reactor feed stream. The tubes in the bundle have a radial spacing between tubes that is considerably larger than an axial spacing between tubes. A reactor effluent flows through the shell without a substantial change in direction while the first and second heat transfer surfaces cool the effluent.

### BACKGROUND

### Technical Field

The present disclosure is generally directed to integration of heat recovery from, and cooling of, an effluent stream from a reactor in a processing system, and more particularly, but not exclusively, to processing systems including coil wound heat exchangers for such purposes.

### Description of the Related Art

Heat Exchangers of various types are used to recover heat from, and separately to further cool, reactor effluent streams. The recovery of heat with known heat exchangers may be accomplished via indirect heat exchange with process streams to be heated for additional downstream applications, or by generating steam. In most cases, the resulting temperature of the reactor effluent leaving the heat exchanger is still too high for downstream compression, recycle or separation steps. As a result, additional cooling with separate units downstream of the heat exchanger is required to lower reactor effluent temperature for downstream separation of useful products or compression and recycle to the reactor.

For example, U.S. Pat. No. 10,962,302 describes the form and function of heat exchangers used in catalytic dehydrogenation, fluid catalytic cracking, and catalytic reforming. These heat exchangers may be grouped under the umbrella term Combined Feed Effluent (“CFE”) heat exchangers. In particular, this reference describes a process referred to as an OLEFLEX process that is shown in FIG. 1 and FIG. 2 where reactor effluent is cooled from 584 degrees Celsius (“C”) to 142 degrees C against a combination of vapor feed and hydrogen rich recycle gas. Although the inlet temperature of the feed gas is quite low (~40 degrees C), the heat capacity of the hot fluid relative to the cold fluid is such that the effluent gas cannot be cooled below 140 degrees C before a temperature pinch occurs. The effluent is cooled further in a downstream cooler prior to compression and recycle in order to minimize the temperature prior to phase separation and recycle of the vapor portion using a compressor.

U.S. Published Application No. 2020/0290939 describes methods for improving the energy conversion from heat available in a hydrocarbon feed stream during the production of olefins. In particular, FIG. 3 of this reference shows a hydrocarbon feed stream and a hydrogen gas feed stream which are pressurized to 30 bara and heated by indirect heat exchange against an expanded effluent stream from a furnace reactor.

The effluent stream is cooled to 130 degrees C in the feed effluent heat exchanger, and then further cooled to 30 degrees C in a separate cooler downstream of the feed effluent heat exchanger.

In the above and other examples of known heat exchangers, a relatively low pressure, high temperature reactor effluent may be cooled against an incoming feed stream of a known heat exchanger. The reactor effluent is further cooled in one or more separate downstream units to enable downstream separation or compression and recycle to the reactor. For large scale production of bulk chemicals such as ethylene, propylene, iso-butylene, and others, the scales of production are such that the heat exchange equipment includes multiple units with interconnecting pipework between the units to cool the reactor effluent to a sufficient level for separation or compression and recycle.

As a result, the effluent flow is separated and distributed to individual units before each heat exchange section, and then the constituent parts are recombined and collected before being redistributed to the next heat exchange section and so on. The multiple changes in the direction of flow lead to a high pressure drop as well as potential for maldistribution between individual units or within individual flow channels or layers. The high pressure drop is particularly disadvantageous where the downstream processing of the reactor effluent involves a reaction with yields that are pressure dependent and/or when the reactor effluent is below atmospheric pressure such that large compression ratios are required. However, there are additional deficiencies and disadvantages with known heat exchangers.

In particular, the use of multiple units with interconnecting pipework increases the overall cost and space requirements of the system. Known heat exchange systems also use significant amounts of power for recycling due to the high cost of operating compressors to pressurize the reactor effluent downstream of the heat exchanger, which further increases costs. Capital and operating costs may be further increased by intercoolers and/or aftercoolers between compression stages. In addition, use of known heat exchangers may limit the amount of heat that can be recovered to heat the feed compared to heat recovered by steam generation, and thereby produce a relatively large amount of greenhouse gas emissions, since recovering a significant amount of heat via production of steam during processing essentially requires burning fuel to generate steam. These and other factors of known heat exchangers decrease efficiency and lead to an overall lower return on investment.

It would therefore be desirable to have a heat exchanger that overcomes the deficiencies and disadvantages of known heat exchange systems.

### BRIEF SUMMARY

The present disclosure is generally directed to the thermal integration of refinery and petrochemical processes, and in particular, but not exclusively, to integration of CFE heat exchangers with downstream cooling. Embodiments of the disclosure provide a reactor effluent cooling system which can effectively cool the effluent from a reaction system to a temperature suitable for re-compression and/or separation of desirable products from material to be recycled, along one single axis, without substantial changes in direction and without the need to redistribute the fluids between multiple units in parallel.

Embodiments of the disclosure may include heat exchange devices, systems, and methods whereby a coil wound heat exchanger is configured with at least two heat transfer surfaces. The heat transfer surfaces can be provided in a number of different form factors or arrangements. For example, the heat transfer surfaces may each be a respective plurality of coiled tubes or tube bundles. The tubes associated with each heat transfer surface define respective circuits for the flow of thermal transfer media through certain portions of the heat exchanger for interaction with effluent flow through the heat exchanger. The first circuit corresponding to the tubes of the first heat transfer surface may be used to recover heat from the effluent stream through the heat exchanger via indirect heat transfer against at least one of a feed stream, by generating steam, or via other intermediate fluids. The second circuit corresponding to the tubes of the second heat transfer surface is used to further cool the effluent by indirect heat transfer with at least one additional stream without withdrawing the effluent between the circuits. The first and second circuits are housed within a common shell and the effluent flows through the shell from an inlet to an outlet in a direction parallel to the axis of the shell with no substantial changes in direction. More than two tube circuits or bundles may be used, for instance a first tube circuit may cool an effluent stream by generating steam from a boiler feed water, a second tube circuit may further cool an effluent stream and recover heat by indirectly heating a feed stream, and a third tube circuit may further cool an effluent stream by indirect heat transfer with a coolant stream. Other configurations are possible.

The first and second circuits can be arranged in such a way to create parallel or alternate sub-circuits which may be activated separately to increase or reduce the feed or coolant flow depending on operational duty. For example, the first circuit may be a bundle of multiple tubes that each have a respective inlet and that are grouped together in a tubesheet. As a result, each inlet and corresponding tube of the bundle may be a respective sub-circuit of the first circuit. In an embodiment, a heat exchanger is provided in a form factor of a coil wound heat exchanger configured to have two sets or bundles of coiled tubes wound around a mandrel in a single shell. Each bundle of tubes may be wound around separate mandrels with a common axis, or may be wound around a single common mandrel. The tubes are coiled with an axial and radial spacing between the tubes with the radial spacing being much larger than the axial spacing. In some embodiments, the radial spacing may be ten or more times greater than the axial spacing.

As a result, the concepts of the disclosure replace heat exchanger systems with multiple units in parallel or in series and the associated pipework for the same with a single heat exchanger shell that cools a reactor effluent to a desirable temperature for further downstream processing without a substantial change in direction of effluent through the shell. The concepts of the disclosure therefore reduce the overall capital and operational costs of heat exchanger systems, while also reducing pressure drops in the system, thereby improving yields.

Additional benefits and advantages of the concepts of the disclosure will be described in detail with reference to the accompanying drawings, or otherwise appreciated by those of ordinary skill in the relevant art upon a review of the present disclosure.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale in some figures. For example, the shapes of various elements are selected, enlarged, and positioned to improve drawing legibility. In other figures, the sizes and relative positions of elements in the drawings are exactly to scale. The particular shapes of the elements as drawn may have been selected for ease of recognition in the drawings. The figures do not describe every aspect of the teachings disclosed herein and do not limit the scope of the claims.

FIG. 1A is a schematic diagram of a known CATOFIN processing system.

FIG. 1B is a schematic illustration of a heat recovery system of the known processing system of FIG. 1A.

FIG. 2 is a schematic diagram of an embodiment of a processing system with a split reactor effluent to a heat exchanger according to the present disclosure.

FIG. 3 is a schematic diagram of an embodiment of a processing system with a reactor effluent provided directly to a heat exchanger according to the present disclosure.

FIG. 4A is a schematic illustration of an embodiment of a heat exchanger with a single mandrel according to the present disclosure.

FIG. 4B is a schematic illustration of an embodiment of a heat exchanger with multiple separate mandrels according to the present disclosure.

FIG. 5 is a schematic illustration of a spacing between tubes in a heat exchanger according to the present disclosure.

FIG. 6 is an isometric view of a heat exchanger according to the present disclosure.

FIG. 7 is a schematic cross-sectional view along a longitudinal axis of the heat exchanger of FIG. 6.

FIG. 8 is a schematic illustration of a processing system including the heat exchanger of FIG. 6.

### DETAILED DESCRIPTION

Persons of ordinary skill in the relevant art will understand that the present disclosure is illustrative only and not in any way limiting. Other embodiments of the presently disclosed systems and methods readily suggest themselves to such skilled persons having the assistance of this disclosure.

Each of the features and teachings disclosed herein can be utilized separately or in conjunction with other features and teachings to provide heat exchanger devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are exactly to scale and intended to limit the dimensions and the shapes of the components.

In general, the concepts of the disclosure are used for heat recovery from reactor effluents in a number of processes to reduce overall pressure drop, reduce equipment count, and improve the return on investment of the technology. The return on investment improvement is a result of a reduction in piping and plot space as well as a lower pressure drop, which may allow a reactor to be operated at a lower pressure with improved yields, or may reduce the compression costs associated with downstream separation and recycle of an unreacted portion of the effluent. The concepts of the disclosure can be used with any heat recovery scheme which exchanges heat indirectly between a hot effluent and a cold feed stream followed by additional indirect cooling of the effluent against an additional stream.

While the present disclosure will proceed to describe certain examples of heat exchanger systems and heat exchange devices that may be particularly advantageous for petrochemical processing and refining, such as at least with respect to the dehydrogenation of propane to make propylene, it will be appreciated that the concepts of the disclosure can be applied to a broad range of technologies and industries. In particular, the concepts of the disclosure can be applied equally to any industry or technology utilizing a heat exchanger in communication with a separate and additional downstream cooler, such as at least in the offshore, refinery, power, petrochemical, or paper and food industries. Further, the concepts of the disclosure can be applied to technologies and industries where it is advantageous to maximize ratios of heat transfer to pressure drop. Thus, the concepts of the disclosure are not limited to the examples provided below.

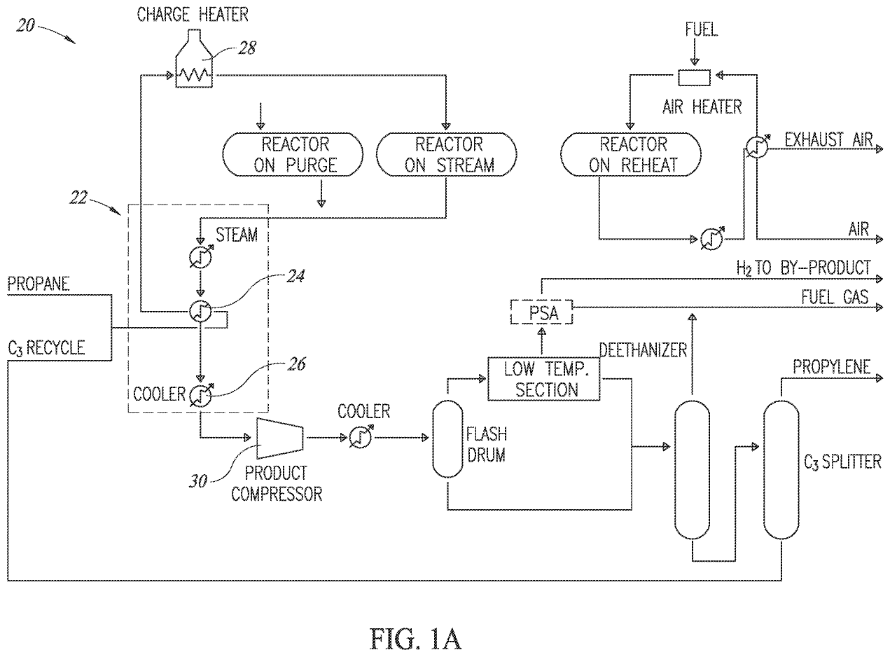

FIG. 1A and FIG. 1B are schematic representations of a known processing system 20. In particular, FIG. 1A is a schematic diagram of a heat recovery system 22 of a CATOFIN plant. Unless the context clearly dictates otherwise, “CATOFIN” means “catalytic olefin” and refers to technology for catalytic dehydrogenation of alkanes to yield alkenes, including, but not limited to, dehydrogenation of isobutene, n-butane, or propane to isobutylene, n-butenes, or propylene, respectively. FIG. 1B is a schematic illustration of the heat recovery system 22 of the processing system 20 illustrating an example location and arrangement of aspects of the heat recovery system 22.

Beginning with FIG. 1A, the processing system 20 includes a heat recovery system 22 with feed effluent heat exchangers 24 and coolers 26 downstream of the feed effluent heat exchangers 24. The on-stream reactor effluent is cooled from 575 degrees C to approximately 30-40 degrees C by the heat recovery system 22 by generating steam, preheating the feed in the feed-effluent heat exchangers 24, and rejecting heat to cooling water in the coolers 26. The reactor feed and the recycle flow to the on-stream reactor are first heated by reactor effluent in the heat exchangers 24 followed by heating with a charge heater 28. In an embodiment, the heat exchangers 24 and coolers 26 are shell and tube devices, but with special design considerations further explained below. More recently, with the rise in fuel costs, or to minimize emissions from burning fossil fuels, it is desirable to maximize heat recovery at the expense of steam production by preheating feed to a temperature of 400-475 degrees C against an effluent inlet temperature of around 490 degrees C. Due to the temperatures involved, the tubes in the system 20 are typically austenitic stainless steel. Although the amount of heat recoverable may be limited by coking and metallurgical considerations at the hot tube sheet, generally the heat exchanger should have a very high efficiency. The required efficiency is normally expressed in terms of heat exchange “effectiveness” which is defined as the heat transferred from the cooling fluid to the warming fluid as a percentage of the maximum possible heat recovery. In some cases there are additional constraints or requirements. For example, the Catofin™ process for dehydrogenation of propane or propane butane combinations requires that the reaction is carried out under a reduced pressure so the pressure loss of the gas must be kept as low as possible to maintain a high selectivity. In an embodiment, the system 20 is designed for high recovery (low steam) applications and the thermal effectiveness is greater than 90%, which leads to a high surface area requirement.

In operation, effluent leaving the heat exchangers 24 is further cooled in a separate set of shell and tube effluent coolers 26 prior to product compression and recycle. Since the reactor operates below atmospheric pressure, minimizing the pressure drop of the effluent through the heat recovery sections is an important design factor, both to improve reactor yield and to minimize compression power of compressor 30.

Turning to FIG. 1B, the heat recovery system 22 is illustrated in additional detail. The heat exchangers 24 may include several shell and tube heat exchangers arranged in parallel or in series and the coolers 26 may include several shell and tube effluent coolers arranged in parallel or in series. The exact number and arrangement of heat exchangers 24 and coolers 26 can be selected based on operational duty of the system 20 (FIG. 1A) and other design factors. FIG. 1B also illustrates that the heat exchangers 24 and coolers 26 are connected by significant lengths of pipe, along with various bends, tees, and elbows. The additional length of pipe as well as additional connectors produces the disadvantages described herein with known systems, namely a high pressure drop, potential for maldistribution and fouling, decreased yields, increase in overall capital cost and space utilized by the system, use of significant amounts of power for recycling and the associated increase in costs, along with production of large amounts of emissions, among others.

There are additional design considerations and disadvantages associated with a high recovery (low steam) processing system 20 since the amount of heat recoverable may be limited by coking and metallurgical considerations at the hot tube sheet such that at least some steam generation may be required to reduce the effluent temperature. For example, and with reference to FIG. 1A and FIG. 1B, in addition to coolers 26, the system 20 may include a reactor effluent steam generator (“RESG”) that cools a portion of the reactor effluent from 575 degrees C to around 295 degrees C while producing high pressure steam, such as steam at approximately 44 bara, while the remainder bypasses the steam generator. The bypass around the RESG is open, and while the RESG itself has an outlet temperature of 295 degrees C, the inlet to the heat exchangers 24, after mixing, is reduced to below 500 degrees C.

The heat exchangers 24 are the second cooler installed after the RESG. The heat exchangers 24 cool reactor effluent while preheating feed to the charge heater 28 to 400-475 degrees C. Shell and tube heat exchangers applied in this service are designed with effluent flowing on the tube side (hot side) due to the extremely low allowable pressure drop and potential fouling, as described above. The feed, therefore, is allocated on the shell side (cold side). This arrangement leads to very large surface area requirements due to very low heat transfer coefficient on the tube side. As such, multiple parallel heat exchangers are utilized to meet these design considerations. The large shell side volume presents a challenge to configure the shell side to ensure proper distribution and temperature uniformity on wet surfaces.

In addition, there are special considerations with respect to the expansion joint mechanisms in the heat exchangers 24. Trying to adopt traditional expansion joint solutions such as flanged and flue or internal bellows can be very challenging due to the design, operating conditions, and the size of the heat exchangers 24.

Still further, shell side flow distribution should be addressed to ensure uniformity of the thermal expansion across all the tubes in the tubesheet. To ensure even distribution of the effluent flow to the tubes, the inlet pipe from the steam generator and/or bypass mixer is configured such that the pipe elbow is at least 5 pipe diameters from the tube sheet. Such an arrangement utilizes additional space while also potentially producing a pressure drop. Some examples of known heat exchangers 24 also utilize a special distributor design to minimize the variation in temperature across the tubesheet, which increases costs and complexity in the system 20.

The coolers 26 downstream of the heat exchangers 24 cool the reactor effluent (tube side) as low as possible using a coolant (shell side)that may be an open or closed loop cooling water system, or a closed loop glycol water cooling system or other aqueous or non-aqueous based liquid coolant system. The reactor effluent is cooled to a temperature as close as possible to the coolant temperature to allow effective compression of the reactor effluent vapors in the product gas compressor 30. Due to the very low pressure drop allowed on the effluent side, multiple units in parallel are utilized, and preferably in the same number as the heat exchangers 24. Such an arrangement leads to very low velocity and risk of stagnation on the cooling water (CW) shell side of the coolers 26. Effluent coolers may experience fouling resulting from low cooling water velocity, especially if the cooling water system is not a closed loop. Tubes are in carbon steel due to low temperature; however, corrosion may occur as a result of cooling water stagnation. As a result, the shell side of the coolers 26 utilize technologies to minimize stagnation, but it can be very challenging to design for sufficient velocity, such as greater than 0.6 meter per second (“m/s”), or more preferably greater than 1.0 m/s due the above factors.

In summary, the combination of high heat recovery and low pressure drop in the heat exchangers 24 and coolers 26 present a challenge for the design of shell and tube heat exchangers in the system 20. For example, to achieve low pressure drop, the effluent flows on the tubeside, and the tube diameter is greater than 25 millimeters (“mm”). Further, the heat transfer resistance is much higher for the tubeside fluid, and a large number of tubes are utilized, which results in multiple units used in parallel to accomplish effective cooling. High effectiveness, such as greater than 90% countercurrent flow, is desired for the heat exchangers 24, and the exchanger is relatively long. The shellside volume is large, it is generally not possible to fully utilize the available shellside pressure drop, and shellside distribution is poor, which can lead to uneven thermal expansion between individual tubes. The system 20 may also have the additional disadvantages described above.

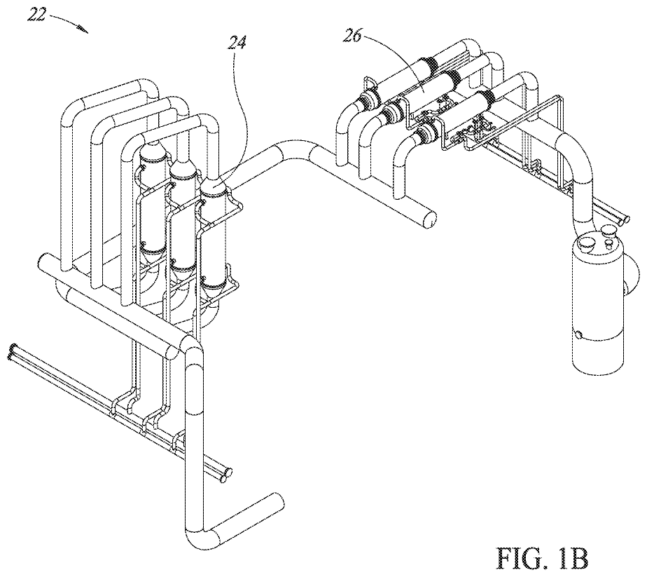

FIG. 2 is a schematic diagram of an embodiment of a processing system 100. In an embodiment, the processing system 100 is a CATOFIN plant that differs from system 20 as described below, although the present disclosure is not limited thereto.

The system 100 includes a heat exchanger 102, a heater 104, a reactor 106, and a steam generator 108. The heat exchanger 102 is in communication with the heater 104, which is in communication with the reactor 106. The reactor 106 is operable to output an effluent with at least a portion of the effluent in communication with the steam generator 108. The steam generator 108 and the remaining portion of the effluent are in communication with the heat exchanger 102. In summary, the heat exchanger 102 is operable to cool the effluent from the reactor 106 by recovering heat from the effluent via indirect heat transfer against at least one of a reactor feed stream, by generating steam, or via other intermediate fluids.

Unless the context and language clearly dictates otherwise, the phrase “reactor feed stream” or “feed stream” means chemical feedstocks derived from refined or partially refined petroleum fraction, principally for use in the manufacturing of fuels, chemicals, synthetic rubber, and a variety of plastics and expressly includes, but is not limited to, feeds used for processes to produce desirable products by hydroprocessing, such as turbine fuel, diesel fuel and other products referred to as middle distillates, as well as lower boiling hydrocarbon liquids, such as naphtha and gasoline, gas oils and heavy gas oils recovered from crude oil by distillation. Examples of feedstocks for the “reactor feed stream” or “feed stream” further include, but are not limited to propane or butane used to produce olefins by catalytic dehydrogenation (CATOFIN), n-butane or a mix of n-butane and n-butenes to produce 1,3 butadiene, heavy reformate, transalkylation xylenes or mixed xylene feed streams mixed with hydrogen for production of paraxylene. In all cases the feed stream may consist of fresh feed mixed with unreacted feed recycled from a separation section.

The heat exchanger 102 includes an inlet 110 and an outlet 112 with a plane 114 through the heat exchanger 102. A first heat transfer surface 116 is arranged in a first portion 118 of the heat exchanger 102 on a first side of the plane 114 and a second heat transfer surface 120 is arranged in a second portion 122 of the heat exchanger 102 on a second side of the plane 114 opposite to the first side. The first and second portions 118, 122 of the heat exchanger 102 may correspond to portions of a shell of the heat exchanger 102 that are integral with each other in a single, unitary shell, as further described below. As a result, the heat exchanger 102 defines a flow path for the effluent of the reactor 106 from the inlet 110 to the outlet 112 without a substantial change in direction of the effluent. The first and second heat transfer surfaces 116, 120 interact with the reactor effluent along the flow path through the heat exchanger 102 without changing the direction of flow of the reactor effluent. Such first and second heat transfer surfaces 116, 120 may be a respective plurality of coiled tubes or tube bundles that define respective first and second circuits (or sub-circuits associated with each tube) for the flow of thermal transfer media through the heat exchanger 102.

In operation, a feed stream, which is a propane feed in a non-limiting example, is conveyed along flow line 124 and enters the heat exchanger 102 at a point above the plane 114 and interacts with the first heat transfer surface 116. Unless the language and context clearly dictate otherwise, a “flow line” is interpreted to mean any structure capable of conveying a fluid and includes, but is not limited to, conduits, pipes, and the like. The feed stream 123 from flow line 124 is heated against the reactor effluent stream in the heat exchanger 102 via the first heat transfer surface 116 and exits the heat exchanger 102 via flow line 126 to the heater 104. The heater 104 is operable to raise a temperature of the feed stream from the first heat transfer surface 116 to a selected temperature for a reaction at the reactor 106. The heated feed stream is then provided from the heater 104 to the reactor 106 via flow line 128. As referenced above, the reactor 106 is operable to output an effluent along line 130. The reactor effluent in line 130 may be split into two portions, namely a first effluent portion 130A and a second effluent portion 130B. The first effluent portion 130A is cooled in the steam generator 108. The second effluent portion 130B bypasses the steam generator 108 along line 132. The first and second effluent portions 130A, 130B are then combined and mixed downstream of the steam generator 108. The resulting combined effluent stream is provided to the inlet 110 of the heat exchanger 102.

The combined effluent stream passes through the heat exchanger 102 from the inlet 110 to the outlet 112 and is successively cooled against the first and second heat transfer surfaces 116, 120. In an embodiment, the first portion 118 of the heat exchanger 102 is an upper portion of the heat exchanger above the plane 114 with the heat exchanger 102 generally arranged vertically. Thus, the combined effluent is first cooled against the incoming feed stream 124 via first heat transfer surface 116. The second portion 122 of the heat exchanger 104 may be a lower portion of the heat exchanger 102 with a flow of coolant interacting with the second heat transfer surface 120 along lines 134, 136. The second heat transfer surface 120 cools the combined effluent after the effluent passes the first heat transfer surface 116. As a result, the first and second heat transfer surfaces 116, 120 successively cool the combined effluent stream in a direction parallel to an axis of the heat exchanger 102 and without a substantial change in direction of the combined effluent stream. After cooling, the combined effluent stream exits the outlet 112 for further processing along line 138.

For example, the cooled effluent in line 138 may be fed to a compressor 140 in communication with the outlet 112 of the heat exchanger 102. The compressor 140 is in communication with a separation section 142 and drives the cooled effluent flow through the separation section 142. The separation section 142 is illustrated schematically with a dashed box indicating that the separation section 142 may include various known stages, devices, and systems, such as at least those downstream of compressor 30 in FIG. 1A, for separation of any useful products and/or byproducts along line 144 and recycle of unreacted feed along flow line 146 to be mixed with fresh feed, such as from flow line 123, to form the feed stream that is provided to the first heat transfer surface 116 via flow line 124, and eventually to the reactor 106 as described herein. As a result, the reactor feed that is heated via thermal transfer against the reactor effluent at the first heat transfer surface 116 may include fresh feed via line 123 as well as recycled and unreacted feed from the separation stage 142 along line 146.

In some embodiments, a pressure change between the outlet 112 of the reactor 106 and a suction or intake of the compressor 140 includes no more than 8 velocity heads, and preferably less than 8 velocity heads, in addition to the head loss associated with pressure drop across the heat exchanger and straight pipe runs. A “velocity head” is a common method for estimating the losses in a pipe system due to fittings such as bends, elbows and tees. Perry's Chemical Engineering handbook 7^{th} Edition Section 6-18 Table 6 -6 lists the additional frictional loss for turbulent flow through various fittings in terms of the number of velocity heads (“K”). Pressure drop (“DP”) associated with fittings may be calculated according to the below formula.

DP=SK×0.5×(density)×(velocity)\hat{ }2

In the formula, SK is a sum of the number of velocity heads in the system and the density (kg/m3) and velocity (m/s) are calculated based on the flow and pipe dimensions. Thus, the pressure change or pressure drop (DP) in the system 100 is largely attributable to the heat exchanger 102, rather than intermediate piping and other structures, and the sum of the velocity heads (K) due to changes in direction due to bends, elbows and tees in the system 100 (as well as other systems described herein) is less than 8.

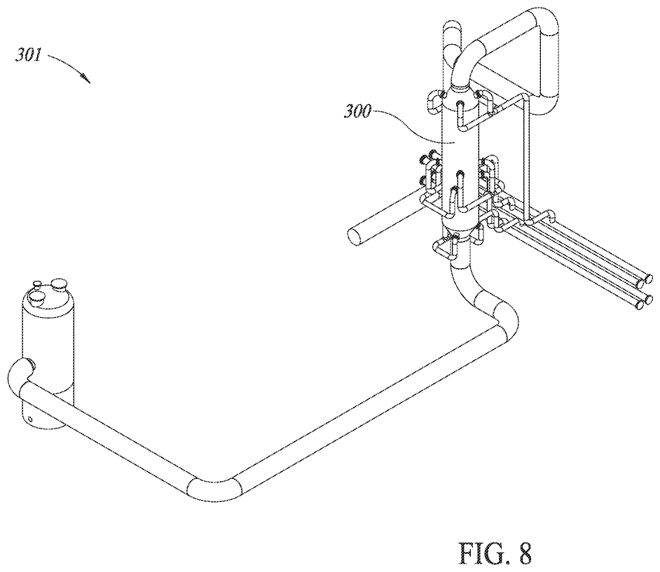

In a non-limiting example utilizing the heat exchanger concepts of the disclosure and described further with reference to FIG. 8, the summed K values are 3.5 (seven long radius elbows each with K value 0.5). By contrast in known system 20 described with reference to FIG. 1A and FIG. 1B, there are necessarily a large number of changes in direction due to the need to divide the flow between the multiple exchangers 24 in parallel, and then collect and redistribute the flow to the downstream coolers 26. For example, in the heat recovery system 22 of FIG. 1B and the system 20 of FIG. 1A that includes such heat recovery system 22, there are 10 long radius elbows (each with K=0.5) and four branching tees (each with K=1.0) for which summed K values may be 9 velocity heads. Because known system 20 includes such additional intermediate piping and other aspects, as described herein, the pressure change between the reactor and the compressor may be greater than 1.5 times the pressure change through the heat exchangers 24 and downstream coolers 26.

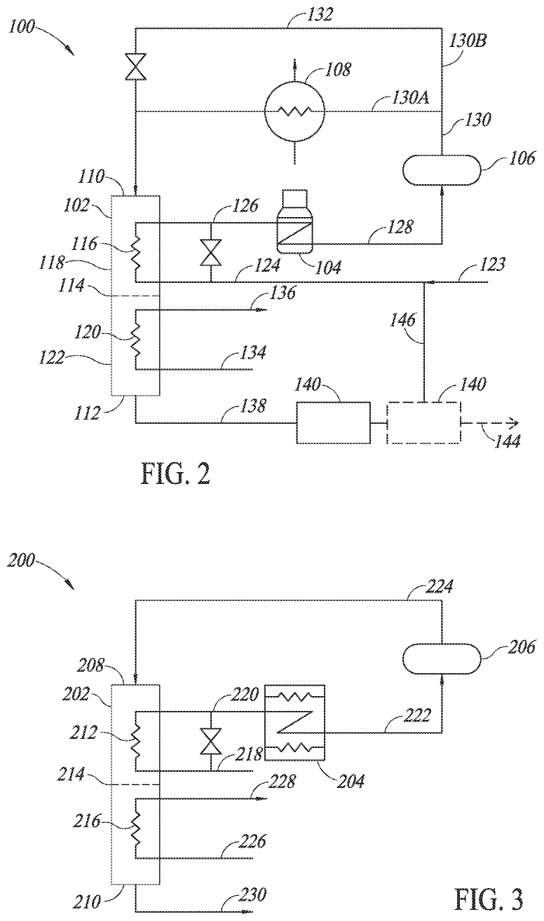

FIG. 3 is a schematic diagram of an embodiment of a processing system 200. While the system 100 may provide the benefits and advantages described herein, additional advantages are achievable by eliminating combustion and reducing or eliminating direct carbon dioxide emissions, as in system 200. The system 200 includes a heat exchanger 202, a heater 204, and a reactor 206 in fluid communication with each other. Notably, the heater 204 of the system 200 may be an electric heater and the system 200 does not include a steam generator as in system 100. As a result, the system 200 does not utilize combustion of carbon-containing gas and therefore does not generate direct emission of carbon dioxide during operation, which further improves the return on investment while lowering the overall environmental impact of the system 200.

In system 200, the heat exchanger 202 may generally be similar to the heat exchanger 102 in system 100. Briefly, the heat exchanger 202 includes an inlet 208 and an outlet 210 with a first heat transfer surface 212 arranged in the heat exchanger 202 above a plane 214 through the heat exchanger 202 and a second heat transfer surface 216 in the heat exchanger 202 below the plane 214. Thus, the heat exchanger 202 has a flow path through the heat exchanger 202 from the inlet 208 to the outlet 210 that passes the first heat transfer surface 212 and the second heat transfer surface 216 in sequential order without a substantial change of direction of fluid flow through the heat exchanger 202.

During operation of the system 200, a feed stream 218 enters the heat exchanger 202 above the plane 214 and interacts with the first heat transfer surface 212. In an embodiment, the feed stream 218 is a hydrocarbon feed or a hydrocarbon feed mixed with hydrogen and may consist of fresh feed mixed with recycled unreacted feed recycled from a separation section. The feed stream exits the heat exchanger 202 along line 220 and is provided to the heater 204. The heater 204 may be an electrical heater with radiant heating elements mounted on a refractory lined vessel operable to heat the feed stream to a suitable temperature for input to the reactor 206. After the feed stream is heated by the heater 204, the feed stream is provided to the reactor 206 along line 222. The reactor 206 is operable to output an effluent directly to the inlet 208 of the heat exchanger 202 along line 224. The heat exchanger 202 cools the effluent with the feed stream 218 at the first heat transfer surface 212 as well as with a separate coolant stream provided to the second heat transfer surface 216 along lines 226, 228. Unless the context and language clearly dictates otherwise, the term “coolant” should be construed broadly to mean a liquid or gas that is capable of being used to remove heat and includes, but is not limited to, cooling water in an open or closed loop system, glycol water in a closed loop cooling system, or other aqueous or non-aqueous based liquids in such coolant systems. After cooling, the effluent leaves the heat exchanger 202 for further processing at 230.

Thus, in some embodiments, the effluent from the reactor 206 is not split into constituent parts for additional cooling, but rather, is provided directly from the reactor 206 to the heat exchanger 202. Such an arrangement further reduces piping, equipment costs, plot space, and pressure drop in the system 200. However, because the reactor effluent is not cooled prior to entering the heat exchanger 202, the effluent incident to the heat exchanger 202 may have a higher temperature relative to system 100. As a result, the feed stream 218 may likewise be heated to a higher temperature than in the system 100. In some embodiments, the higher temperature of the feed stream 218 reduces operational duty of the heater 204 and enables use of an electric heater rather than a heater that operates based on combustion of carbon-containing gas.

It can be appreciated that in order to minimize or even avoid altogether the combustion of fuel and steam generation, the heat recovery efficiency is preferably very high to ensure that the maximum possible energy is extracted from the hot effluent stream. The thermal effectiveness may be defined based on the amount of heat recovered from an effluent stream divided by the theoretical maximum possible heat recovery. The thermal effectiveness of the heat exchanger 102 in FIG. 2 and the heat exchanger 202 in FIG. 3, as well as the other heat exchangers described herein, will generally be higher than 85% and preferably higher than 90%. Known systems include generally straight tubes or channels used for the CFE that cannot achieve the same level of effectiveness as the concepts of the disclosure in a single heat exchanger shell. It has been found that using coiled tubes wound around a mandrel provides a thermal effectiveness greater than 85% in a single shell or a much reduced number of individual shells compared to known solutions, which has the benefits and advantages described herein.

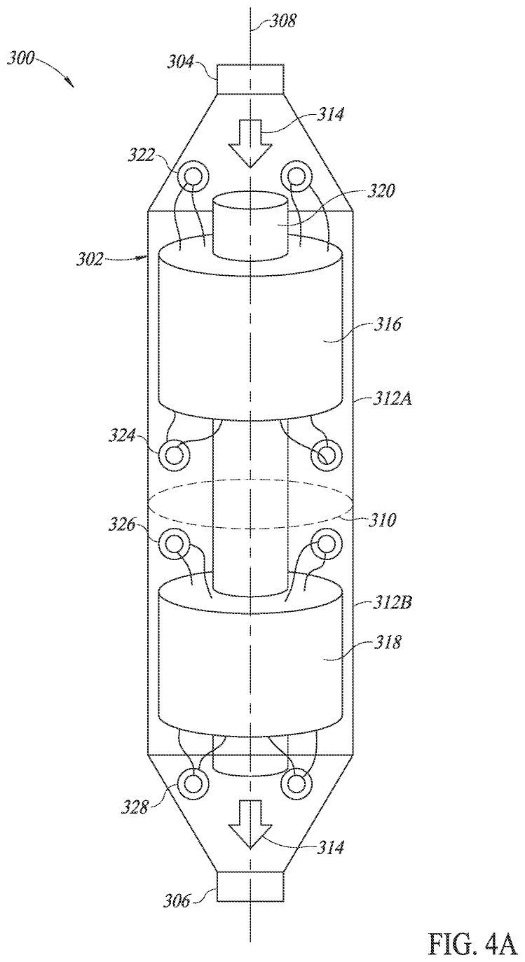

FIG. 4A is a schematic illustration of an embodiment of a heat exchanger 300. Except as otherwise provided herein, the heat exchanger 300 may be similar to the heat exchangers 102, 202 described with reference to systems 100, 200, respectively. The heat exchanger 300 includes a shell 302 that may generally be arranged vertically as shown in FIG. 4A. The shell 302 includes an inlet 304 and an outlet 306 to define a flow path through the shell 302. Further, the shell 302 has a longitudinal axis 308 that may be a vertical centerline through the shell 302 with the inlet 304 and the outlet 306 centered on the axis 308. A plane 310 passes through the shell 302 and the axis 308. In an embodiment, the plane 310 is a horizontal plane through the shell 302 that intersects the longitudinal axis 308 through the shell 302 such that the plane 310 is perpendicular to the axis 308.

The plane 310 separates the shell 302 into a first portion 312A and a second portion 312B and may be a conceptual dividing line of the shell 302 to provide additional context regarding concepts of the disclosure. In practice, the shell 302 is a single, integral, unitary component with a continuous body including the first and second portions 312A, 312B. The first portion 312A of the shell 302 is an upper portion of the shell 302 on a first or upper side of the plane 310 and the second portion 312B of the shell 302 is a lower portion of the shell 302 on a second or lower side of the plane 310 opposite to the first side. Further, the inlet 304 leads into the first portion 312A of the shell 302 and the second portion 312B leads to the outlet 306 of the shell 302. As a result, a flow path through the shell 302 traverses the inlet 304, the first portion 312A of the shell 302, the second portion 312B of the shell 302, and the outlet 306 in sequential order. The flow path thus follows the longitudinal axis 308 of the shell 302 without a substantial change in direction of fluid or effluent along the flow path, as generally represented by arrows 314.

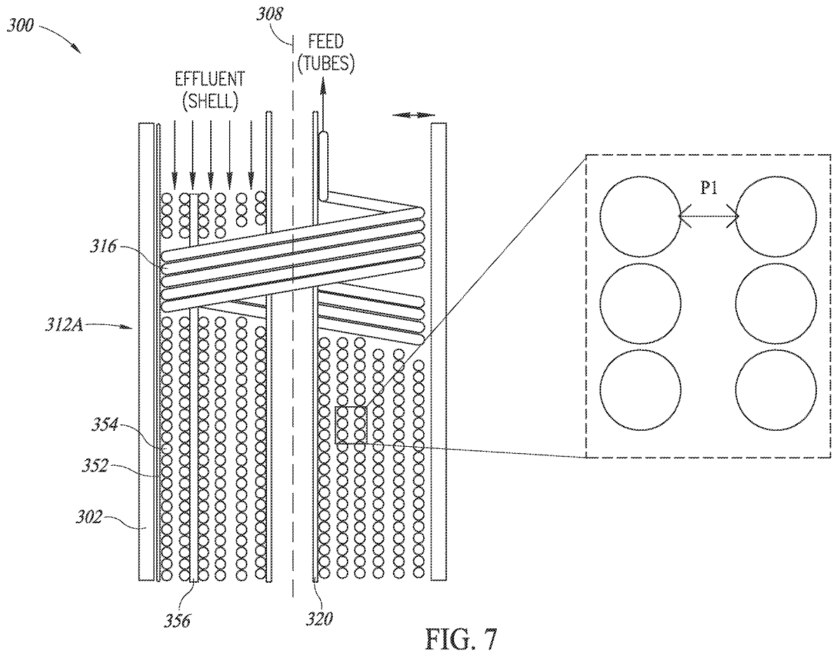

The heat exchanger 300 also includes a first heat transfer surface 316 and a second heat transfer surface 318. In one or more embodiments, the plane 310 is a horizontal plane through the shell 302 that is in between the first transfer surface 316 and the second heat transfer surface 318, rather than a horizontal plane through a center of the shell 302, as described above. Further, the plane 310 may be a reference surface across which all of the effluent flows without a substantial change in direction, as described herein. The first heat transfer surface 316 is arranged in the first portion 312A of the shell 302 while the second heat transfer surface 318 is arranged in the second portion 312B of the shell 302. The first and second heat transfer surfaces 316, 318 are illustrated schematically as cylinders, but in practice, the first and second heat transfer surfaces 316, 318 may include a plurality of coiled tubes with gaps therebetween to increase contact surface area with effluent flowing along the flow path 314, as shown and described in more detail with reference to FIG. 7. For example, the first and second heat transfer surfaces 316, 318 may be distinct coiled tube bundles each containing a respective plurality of coiled tubes arranged around a single mandrel 320 in some embodiments with the respective coiled tube bundles spaced from each other along the mandrel 320.

The mandrel 320 may be aligned with the longitudinal axis 308 such that the first coiled tube bundle or plurality of first coiled tubes corresponding to the first heat transfer surface 316 and the second coiled tube bundle or plurality of second coiled tubes corresponding to the second heat transfer surface 318 wrap around the mandrel 320 in successive layers of tubes centered on the longitudinal axis 308. In an embodiment, each of the plurality of coiled tubes or tube bundles corresponding to the first and second heat transfer surfaces 316, 318 may be of generally the same size or length. Further, the single mandrel 320 may be a continuous, integral, unitary structure having a constant diameter over its length. The first and second heat transfer surfaces 316, 318 are connected to sets of tube sheets 322, 324, 326, 328 to achieve the flow schemes described herein. In particular, the tube sheets 322, 324, 326, 328 may convey coolant or feed streams to, through, and away from the heat transfer surfaces 316, 318 to recover heat from reactor effluent flowing along the flow path 314, as described herein.

In a further embodiment, the heat exchanger 300 includes more than one mandrel 320, such as in FIG. 4B. The heat exchanger 300 of FIG. 4B includes at least two mandrels 320, namely first mandrel 320A and second mandrel 320B. Each of the first and second mandrels 320A, 320B may be arranged along the axis 308, meaning concentric with the axis 308. Alternatively, the mandrels 320A, 320B may be parallel to the axis 308, but offset from the axis 308 or spaced from the axis 308. The coiled tubes or tube bundle comprising the first heat transfer surface 316 may arranged around the first mandrel 320A and the coiled tubes or tube bundle comprising the second heat transfer surface 318 may be arranged around the second mandrel 320B. Further, each of the mandrels 320A, 320B may have the same or a different size or diameter. For example, the first mandrel 320A may have a smaller diameter and a greater length than the second mandrel 320B. Other variations of the dimensions of the mandrels 320A, 320B are contemplated herein.

Further, the mandrels 320A, 320B be separate and distinct structures that are spaced from each other, or otherwise not in direct fluid communication with each other, in some embodiments. In an embodiment, the mandrels 320A, 320B are optionally in such direct fluid communication via fitting 321 that is shown schematically in dashed lines. Further, in some embodiments, the first transfer surface 316 generally has a larger size or greater length than the second heat transfer surface 318. As a result, the plane 310 between the first and second heat transfer surfaces 316, 318 may be offset or spaced from a center of the shell 302 such that the first and second portions 312A, 312B of the shell 302 are different sizes (i.e., the first or upper portion 312A is larger than the second or lower portion 312B).

The arrangement of the heat exchanger 300 in FIG. 4A and FIG. 4B has a number of advantages over known heat exchangers. In particular, the first and second heat transfer surfaces 316, 318 can cool the reactor effluent along the flow path 314 to a desirable temperature without separate downstream cooling units and without deviating a direction of flow of the effluent substantially away from the longitudinal axis 308. As a result, there is a significantly lower pressure drop in the reactor effluent through heat exchanger 300. The reduction in pressure drop minimizes compression costs and also improves reactor yields for chemical reaction selectivity that favors lower pressures. The pressure drop reduction is attributable, at least in part, to combining effluent cooling processes in the same shell 302, which eliminates piping to pass cooled effluent from the heat exchanger 300 to effluent coolers and the pressure drop associated with entrance loss, bends, and tees for distributing the flow.

Further, the plot space and capital costs associated with the heat exchanger 300 are significantly reduced relative to known heat exchangers. Such benefits are particularly pronounced for effluent at low pressures that utilize large pipework, such as pipes with diameters of 20 inches or larger. Finally, the first and second heat transfer surfaces 316, 318 operate as parallel or alternate heat recovery or cooling circuits in different sections of the heat exchanger 300 with operation capacity that can be varied according to operational duty of the systems incorporating the heat exchanger 300. In other words, coolant capacity through each heat transfer surface 316, 318 may be adjusted in response to operational characteristics of the larger processing system, which optimizes consumption of coolant and enables more efficient processing applications that are responsive to changing demands in a broader system.

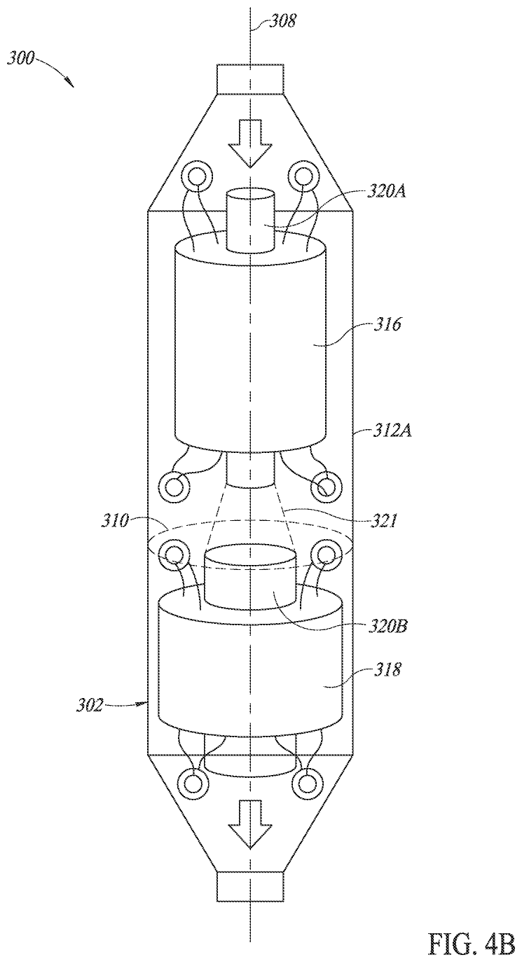

FIG. 5 is a schematic illustration of a spacing between aspects of the first and second heat transfer surfaces 316, 318 in the heat exchanger 300 described herein. As described above, the first and second heat transfer surfaces 316, 318 (FIG. 4A and FIG. 4B) may be distinct bundles of coiled tubes arranged around the longitudinal axis 308 of the shell 302. Each bundle of coiled tubes may include a respective plurality of tubes 330 coiled around the longitudinal axis 308 of the shell 302. The number, size, and arrangement of the tubes in each bundle may be selected according to design factors. In an embodiment, the tubes 330 have a first spacing P1 in a radial direction X perpendicular to the longitudinal axis 308 that is greater than a second spacing P2 in an axial direction Y parallel to, and aligned with, the longitudinal axis 308. In some embodiments, the first spacing P1 is on average 10 times greater, or more, than the average of the second spacing P2. Thus, a ratio of the first spacing P1 to the second spacing P2 may be expressed as >10:1.

The average spacings P1, P2 between the tubes 330 in each bundle of coiled tubes of certain embodiments of the first and second heat transfer surfaces 316, 318 (FIG. 4A and FIG. 4B) is significant because the reduction in pressure drop achievable with the heat exchanger 300 (FIG. 4A and FIG. 4B) is at least partially attributable to flowing effluent on the outside of a structure with relatively large radial spacing between layers. In other words, the specific spacing P1, P2 described herein enables a further reduction in pressure drop by providing a large radial spacing between tubes 330 that does not impede the effluent flow through the heat exchanger 300 (FIG. 4A and FIG. 4B) or otherwise substantially change the direction of the effluent flow through the heat exchanger 300 (FIG. 4A and FIG. 4B). The comparatively smaller second spacing P2 increases surface area of the tubes 330 in contact with the effluent to improve heat transfer, while also not being large enough to change the direction of the effluent flow substantially away from the longitudinal axis 308. As a result, the spacings P1, P2 between tubes 330 provides further benefits and advantages relative to conventional heat exchangers.

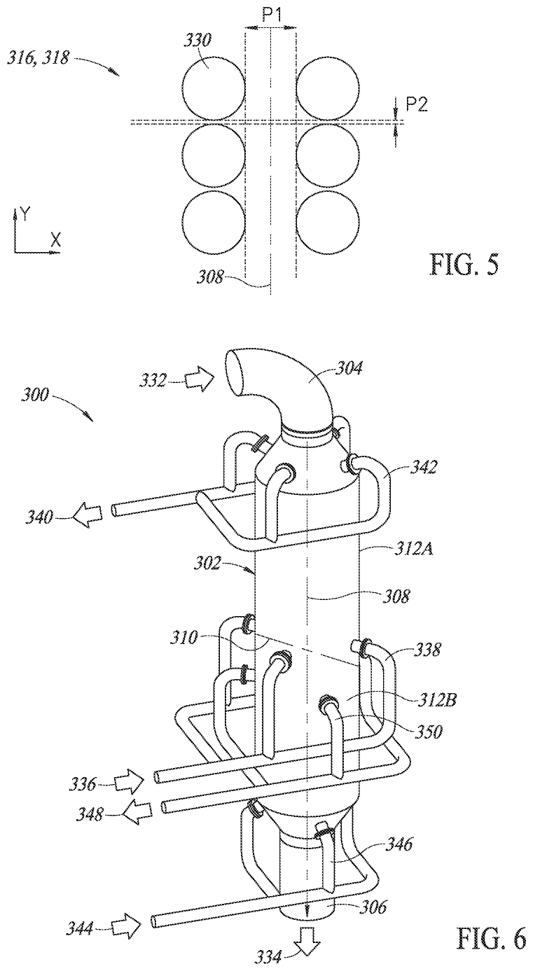

FIG. 6 is an isometric exterior view of the heat exchanger 300 according to at least some embodiments of the disclosure. An effluent stream, such as from a reactor, is provided to the inlet 304 of the shell 302 as indicated by arrow 332. The effluent flows in a direction parallel to the longitudinal axis 308 through the shell 302 to the outlet 306 of the shell 302 for further downstream processing and without a substantial change in direction from the longitudinal axis 308, as indicated by arrow 334. Unless the context dictates otherwise, “without substantial change in direction,” when describing a direction of effluent flow, means that the bulk flow is primarily between the layers of coiled tubes and is parallel to the axis 308, understanding that there may be minor deviations affecting 10% of the bulk total fluid flow or less, or more preferably 5% or less, due to components such as temperature devices or other protuberances that do not significantly affect the direction of the bulk flow. In addition, changes in cross-sectional area of the bulk flow are not considered to be “substantial changes in direction” or deviations from the direction of the bulk flow, so long as the changes in cross section retain a common longitudinal axis. Changes in flow direction at a small scale (i.e., less than a diameter of a single tube) due to turbulence or the turbulent nature of the flow are not considered “substantial changes in direction” or deviations from the longitudinal axis since they do not affect the overall bulk direction of the flow. In at least some examples, “without substantial change in direction,” when describing a direction of effluent flow, means that at least 90% of the bulk flow, or more preferably at least 95% of the bulk flow, is parallel to, or within an acceptable range of deviation from parallel (i.e., within 3 degrees of parallel), to the longitudinal axis 308. In some embodiments, “without a substantial deviation from the longitudinal axis” may have a similar meaning to “without substantial change in direction” provided above.

Arrow 336 corresponds to introduction of a cold feed stream to the heat exchanger 300 along lines 338. As shown in FIG. 6, the lines 338 are connected to the shell 302 above the plane 310 such that the cold feed stream 336 is introduced to the heat exchanger 300 above the plane 310. The cold feed stream 336 is heated via interaction with the effluent stream in the heat exchanger 300 to produce a heated feed stream. The heated feed stream is represented by arrow 340 and exits the heat exchanger 300 proximate the inlet 304, or proximate a top of the heat exchanger 300, along lines 342. Thus, the cold feed stream may be provided to a bottom of the first portion 312A of the shell 302 above the plane 310 and travel vertically upward along the first portion 312A of the shell 302 to the top of the shell 302 before exiting the shell as a heated feed stream at 340 to define a first circuit through the heat exchanger 300.

A second circuit through the heat exchanger 300 includes a coolant stream 344 provided to lines 346 connected to the shell at a bottom of the second portion 312B of the shell 302 and below the plane 310, which also corresponds to a bottom of the shell 302 proximate the outlet 306. The coolant stream 344 is heated against the effluent stream along the longitudinal axis 308 to produce a heated coolant stream 348. The heated coolant stream 348 exits the shell 302 via lines 350 connected to a top of the second portion 312B of the shell, and below the plane 310. Thus, the coolant stream 344 travels vertically upward through the second portion 312B of the shell 302 to complete the second circuit.

In sum, the first circuit is used to recover heat from the effluent stream via indirect heat transfer against at least one of (i) a feed stream; (ii) by generating steam; and/or (iii) by other intermediate fluids. The second circuit is used to further cool the effluent by indirect heat transfer with at least one additional stream without withdrawing the effluent, with the first and second circuits and their arrangement in the heat exchanger 300 providing the benefits and advantages described herein.

FIG. 7 is a schematic cross-sectional view of the first portion 312A of the heat exchanger 300 along the longitudinal axis 308 of the heat exchanger 300. The heat exchanger 300 includes the mandrel 320 arranged along the longitudinal axis 308. The first heat transfer surface 316 may be a bundle of tubes coiled around the mandrel 320. In particular, FIG. 7 provides a representation of the winding angle of the tubes of the first heat transfer surface 316. The overall length of the tubes can be varied independent of a diameter of the shell 302 by adjusting the winding angle relative to a horizontal plane through the shell 302. For example, reducing the winding angle relative to horizontal increases tube density and tube length. The heat exchanger 300 may also include a shroud 352 between the shell 302 and the heat transfer surfaces 316, 318. Additional tubes 354 of the heat exchanger 300 are illustrated schematically to demonstrate the axial and radial spacing between the tubes 354, as described herein.

The tubes 354 may also be arranged in concentric layers that overlap each other from the mandrel 320 to the shroud 352 with each layer separated by spacers 356.

The heat exchanger 300 can overcome many of the deficiencies and disadvantages of known heat exchangers discussed herein. For example, the multiple and separate heat exchangers 24 and coolers 26 of the known system 20 (FIG. 1A and FIG. 1B) are combined in a single shell 302 in the heat exchanger 300. The use of a single shell 302 in heat exchanger 300 eliminates a significant amount of pipework and support structures associated with connecting and supporting multiple shell and tube heat exchangers in series and parallel as in known system 300, which provides the benefits described herein. As noted above, the tube length in the heat exchanger 300 can be varied independent of the shell 302 diameter by adjusting the winding angle. The heat exchanger 300 is therefore more compact, with higher overall heat transfer coefficient than known heat exchangers. The surface area utilized for cooling is less than an equivalent shell and tube exchanger and in some embodiments, the surface area of the heat transfer surfaces 316, 318 may be approximately a third of the surface area in known heat exchangers. In addition, large capacity or operational duty can be accommodated in a single train.

The heat exchanger 300 is more compact than an equivalent shell and tube heat exchanger, which leads to a considerable reduction in equipment size and count. Additionally, replacing multiple exchangers (in series and in parallel) with a single shell leads to a reduction in pipework, structure and installation costs. By eliminating interconnecting pipework and exploiting the spacing between tubes as shown in FIG. 7, pressure drop between the effluent mixing downstream of the steam generator to a compressor can be reduced by approximately 3-5 kPa. It has been found that about half of this pressure drop reduction is from reducing pipe lengths, bends, tees, and elbows in the system, while the other half is from eliminating the combined pressure drop of the multiple heat exchangers 24 and coolers 26 in the system 20 (FIG. 1A and FIG. 1B). The lowest pressure drop may occur on the shell side (i.e., the arrows labelled Effluent (Shell) in FIG. 7). In heat exchanger 300, the effluent flows outside the tubes 354 arranged in concentric layers separated by the spacers 356. By placing the colder feed in the tubes 354, the hot end tubesheet temperature is reduced by about 30 degrees C, which effectively reduces the maximum metal design temperature by the same amount, thereby enabling a higher heat recovery within a constraint of maximum temperature (due to materials limits or concern of coking deposits) than could be achieved if the effluent were placed in the tubes. The layers of tubes also form “passages” for the vapor flow, which are relatively large. As shown in FIG. 7, the radial spacing between layers (outside diameter distance between the tubes) may be more than ten times larger than the axial spacing, since there is only minimal axial separation between individual tubes in each layer. This tube layout minimizes the risk of blockage and provides a relatively large open area normal to the flow, which may enable flow through the layers without a substantial change in direction of the effluent flow, as described herein.

In the heat exchanger 300, the coolant may be cooling water and may flow inside the tubes with a considerably higher velocity (i.e., approximately 1.5-2 meters per second (“m/s”)) than known shell and tube exchangers (<0.7 m/s). It is expected that the higher velocity will be beneficial in promoting higher heat transfer and higher shear stress at the tube wall to provide self-cleaning. Furthermore, the cooling water will drain out, thus reducing the likelihood of, or eliminating the possibility of, stagnating pockets in the tubes. The tube material may be stainless steel, which will further mitigate corrosion.

In a known shell and tube configuration, the effluent flows through all the coolers in parallel to maintain a low pressure. The cooling water inevitably has to flow through all three exchangers in parallel otherwise the effluent cannot be cooled to the desired temperature. Such a process can lead to very low velocity on the shell side if the cooling water flow available is limited. In the heat exchanger 300, there is flexibility to increase the tube winding angle to accommodate low water velocity. In addition, if cooling flow is limited for some reason during operation, it is also possible to isolate cooling water through a subset or sub-circuit of the available tubes of the heat exchanger 300, as described herein, to maintain high water flow velocity in the remaining tubes.

As described above, the feed outlet temperature may be limited to 450 degrees C to minimize the risk of coking at the tubesheet. This temperature may also set the maximum heat recovery limit. The fluid in contact with the tubesheet will tend to be at the prevailing tubesheet temperature, so the metal temperature should also be considered. The tube sheet temperature is primarily determined by the temperature of the tubeside fluid. For a known shell and tube design, such as in heat exchangers 24, the tube side fluid is the hot effluent such that the tubesheet will be close to 490 degrees C.

For the heat exchanger 300, the tube side fluid may be the cold feed, such that the average temperature of the tubesheet will be lower. For a feed temperature of 450 degrees C and effluent temperature of 490 degrees C, the average tubesheet temperature is reduced from 487 degrees C to 451 degrees C. The reduction in tube sheet temperature of the heat exchanger 300 may enable a higher feed outlet temperature.

FIG. 8 is a schematic illustration of a processing system 301 including the heat exchanger 300. In particular, FIG. 8 is provided to demonstrate the reduction in footprint, equipment, connections, support structures, and other advantages of the heat exchanger 300 relative to known system 20. As illustrated in FIG. 8, the multiple heat exchangers 24 and coolers 26 of system 20 (FIG. 1A and FIG. 1B) are replaced by single heat exchanger 300 to provide the advantages described herein. Such an arrangement significantly reduces the pipework of the system 301 relative to system 20 while also reducing pressure drop and providing the other advantages described herein.

In view of the above, one or more embodiments of a heat exchanger system may be summarized as including: a shell having a longitudinal axis with a first portion of the shell on a first side of a plane through the shell and a second portion of the shell on a second side of the plane opposite the first side; a first heat transfer surface in the first portion of the shell; a second heat transfer surface in the second portion of the shell; a feed stream in communication with the first heat transfer surface; a heater in communication with the first heat transfer surface operable to heat the feed stream output from the first heat transfer surface; a coolant stream in communication with the second heat transfer surface; and a reactor in communication with the heater operable to output an effluent flow to the heat exchanger, the heat exchanger configured to cool the effluent flow through the shell along the longitudinal axis of the shell.

In an embodiment, the feed stream is a reactor feed and the coolant stream is water, glycol water, or an aqueous coolant.

In an embodiment, the coolant stream is cooling water in an open loop cooling system.

In an embodiment, the coolant stream is glycol water in a closed loop cooling system.

In an embodiment, the coolant stream is an aqueous or non-aqueous liquid coolant in an open loop cooling system or a closed loop cooling system.

In an embodiment, the shell of the heat exchanger is arranged vertically and the longitudinal axis is a vertical center line through the shell.

In an embodiment, the plane is a horizontal plane through the shell in between the first heat transfer surface and the second heat transfer surface.

The heat exchanger system may further include a first mandrel extending through at least the first portion of the shell and a second mandrel extending through at least the second portion of the shell.

In an embodiment, the first and second mandrels extend along the longitudinal axis of the shell from the first portion of the shell to the second portion of the shell.

In an embodiment, the first heat transfer surface is a plurality of first coiled tubes arranged around the first mandrel.

In an embodiment, the second heat transfer surface is a plurality of second coiled tubes arranged around the second mandrel.

In an embodiment, the heat exchanger system further includes a single mandrel extending along the longitudinal axis of the shell.

In an embodiment, the first and second heat transfer surfaces are respective plurality of coiled tubes arranged around the single mandrel.

In an embodiment, the heat exchanger is configured to cool the effluent flow without a substantial change in direction of the effluent flow.

In an embodiment, the heat exchanger is configured to cool the effluent flow without a substantial deviation of a direction of the effluent flow from the longitudinal axis.

In an embodiment, the heat exchanger system further includes a compressor in communication with the heat exchanger, wherein cooled effluent from the heat exchanger is fed to the compressor and a pressure change between an outlet of the reactor and a suction of the compressor includes no more than 8 velocity heads associated with bends, tees, elbows or other fittings, and is no more than 1.5 times a pressure drop associated with the heat exchanger.

One or more embodiments of a system may be summarized as including: a heat exchanger, including a shell having an inlet and an outlet aligned with a longitudinal axis through the shell along the longitudinal axis from the inlet to the outlet; a first mandrel arranged along the longitudinal axis of the shell; a first heat transfer surface in the shell being a plurality of first coiled tubes arranged around the first mandrel, a second mandrel arranged along the longitudinal axis of the shell, and a second heat transfer surface in the shell being a plurality of second coiled tubes around the second mandrel; a feed stream in communication with the first heat transfer surface; a heater in communication with the first heat transfer surface operable to heat the feed stream from the first heat transfer surface; and a reactor in communication with the heater operable to output an effluent flow to the inlet of the shell, the first heat transfer surface and the second heat transfer surface operable to cool the effluent flow along the flow path.

In an embodiment, the first heat transfer surface and the second heat transfer surface are operable to cool the effluent flow without a substantial change in direction of the effluent flow along the flow path.

In an embodiment, the first transfer surface is operable to heat the feed stream against the effluent flow from the reactor, and coolant is provided to the second heat transfer surface.

In an embodiment, the shell includes a first portion on a first side of a plane through the shell and a second portion on a second side of the plane opposite the first side, and the feed stream enters the heat exchanger in the first portion of the shell.

In an embodiment, the shell of the heat exchanger is arranged vertically with the longitudinal axis being a vertical centerline through the shell, the plane being a horizontal plane passing through a center of the shell.

In an embodiment, the shell of the heat exchanger is arranged vertically with the longitudinal axis being a vertical centerline through the shell, the plane being between the first and second heat transfer surfaces.

In an embodiment, the effluent flow is split into a first portion and a second portion and the system further includes a steam generator in communication with the reactor and operable to cool the first portion of the effluent flow.

In an embodiment, the second portion of the effluent flow bypasses the steam generator.

In an embodiment, the first portion and the second portion of the effluent flow are combined downstream of the steam generator and provided to the inlet of the heat exchanger.

In an embodiment, the heat exchanger system further includes a compressor in communication with the outlet of the heat exchanger, wherein cooled effluent from the outlet heat exchanger is fed to the compressor and a pressure change between an outlet of the reactor and a suction of the compressor includes no more than 8 velocity heads associated with bends, tees, elbows or other fittings, and is no more than 1.5 times a pressure drop between the inlet and the outlet of the shell of the heat exchanger.

One or more embodiments of a method may be summarized as including: providing a feed stream to a first heat transfer surface in a first portion of a shell of a heat exchanger, the first heat transfer surface being a plurality of first coiled tubes arranged a first mandrel in the shell; providing the feed stream from the first heat transfer surface to a reactor; providing a cooling stream to a second heat transfer surface in a second portion of the shell of the heat exchanger, wherein the first portion of the shell is on a first side of a plane through the shell and the second portion of the shell is on a second side of the plane through the shell opposite to the first side, and the second heat transfer surface is a plurality of second coiled tubes arranged around a second mandrel in the shell; providing an effluent flow from the reactor to an inlet of the first portion of the shell; flowing the effluent flow along a flow path through the shell along a longitudinal axis of the shell from the inlet of the first portion of the shell to an outlet of the second portion of the shell; and cooling the effluent flow along the flow path with the first heat transfer surface and the second heat transfer surface.

In an embodiment, cooling the effluent flow includes cooling the effluent flow with the first heat transfer surface and the second heat transfer surface without a substantial change in direction of the effluent flow along the flow path.

In an embodiment, the shell is arranged vertically with the longitudinal axis being a vertical centerline through the shell and the plane being a horizontal plane through a center of the shell and the flow path being along the longitudinal axis of the shell.

In an embodiment, providing the effluent flow from the reactor to the inlet of the first portion of the shell includes splitting the effluent flow into a first portion and a second portion, passing the first portion through a steam generator, bypassing the steam generator with the second portion, combining the first portion and the second portion of the effluent flow downstream of the steam generator, and providing the combined effluent flow to the inlet of the first portion of the shell.

The method may further include, after providing the feed stream to the first heat transfer surface, providing the feed stream from the first heat transfer surface to a heater, heating the feed stream with the heater, and providing the heated feed stream to the reactor.

In an embodiment, providing the effluent flow from the reactor to the inlet of the first portion of the shell includes providing the effluent flow directly from the reactor to the inlet.

The method may further include providing cooled effluent flow from the heat exchanger to a compressor, wherein a pressure change between an outlet of the reactor and a suction of the compressor includes no more than 8 velocity heads associated with bends, tees, elbows or other fittings, and is no more than 1.5 times a pressure drop between an inlet and an outlet of the shell of the heat exchanger.

One or more embodiments of a system may be summarized as including: a heat exchanger, including a shell having a longitudinal axis with a first portion of the shell on a first side of a plane through the shell and a second portion of the shell on a second side of the plane opposite the first side, one or more mandrels arranged along the longitudinal axis of the shell, a first heat transfer surface in the first portion of the shell, and a second heat transfer surface in the second portion of the shell; a feed stream in communication with the first heat transfer surface; a heater in communication with the first heat transfer surface operable to heat the feed stream output from the first heat transfer surface; a coolant stream in communication with the second heat transfer surface; a reactor in communication with the heater operable to output an effluent flow to the heat exchanger, the heat exchanger configured to cool the effluent flow through the shell along the longitudinal axis of the shell; and a compressor in communication with the heat exchanger.

In an embodiment, cooled effluent from the heat exchanger is fed to the compressor and a pressure change between an outlet of the reactor and a suction of the compressor includes no more than 8 velocity heads associated with bends, tees, elbows or other fittings, and is no more than 1.5 times a pressure drop associated with the effluent flow through the heat exchanger.

In an embodiment, the first heat transfer surface and the second heat transfer surface are a respective plurality of coiled tubes arranged around the one or more mandrels.

In an embodiment, the one or more mandrels include a first mandrel extending through at least the first portion of the shell and a second mandrel extending through at least the second portion of the shell.

In an embodiment, the first heat transfer surface is a plurality of first tubes arranged around the first mandrel, and the second heat transfer surface is a plurality of second tubes arranged around the second mandrel.

The above description of illustrated embodiments, including what is described in the Abstract, is not intended to be exhaustive or to limit the implementations to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied outside of the heat exchanger context, and are not limited to the example heat exchanger systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various embodiments of the disclosure. However, one skilled in the art will understand that the disclosure may be practiced without these specific details. In other instances, well-known structures associated with heat exchangers, devices, and methods have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Generally, unless otherwise indicated, the materials for making the invention and/or its components may be selected from appropriate materials such as composite materials, ceramics, plastics, metal, polymers, thermoplastics, elastomers, plastic compounds, and the like, either alone or in any combination.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described embodiments, but should be defined only in accordance with the following claims and their equivalents.

1. A system, comprising:
a heat exchanger, including:
a shell having a longitudinal axis with a first portion of the shell on a first side of a plane through the shell and a second portion of the shell on a second side of the plane opposite the first side;
a first heat transfer surface in the first portion of the shell; and
a second heat transfer surface in the second portion of the shell;
a feed stream in communication with the first heat transfer surface;
a heater in communication with the first heat transfer surface operable to heat the feed stream output from the first heat transfer surface;
a coolant stream in communication with the second heat transfer surface; and
a reactor in communication with the heater operable to output an effluent flow to the heat exchanger,
the heat exchanger configured to cool the effluent flow through the shell along the longitudinal axis of the shell.

2. The system of claim 1, wherein the feed stream is a reactor feed and the coolant stream is water, glycol water, or an aqueous coolant.

3. The system of claim 1, wherein the shell of the heat exchanger is arranged vertically and the longitudinal axis is a vertical center line through the shell, and
wherein the plane is a horizontal plane through the shell in between the first heat transfer surface and the second heat transfer surface.

4. (canceled)

5. The system of claim 1, further comprising:
a first mandrel extending through at least the first portion of the shell; and
a second mandrel extending through at least the second portion of the shell.

6. -8. (Canceled)

9. The system of claim 1, further comprising:
at least one mandrel extending along the longitudinal axis of the shell.

10. The system of claim 9, wherein the first and second heat transfer surfaces are respective pluralities of coiled tubes arranged around the at least one mandrel.

11. The system of claim 1, wherein the heat exchanger is configured to cool the effluent flow without a substantial change in direction of the effluent flow.

12. (canceled)

13. The system of claim 1, further comprising:
a compressor in communication with the heat exchanger, wherein cooled effluent from the heat exchanger is fed to the compressor and a pressure change between an outlet of the reactor and a suction of the compressor includes no more than 8 velocity heads associated with bends, tees, elbows or other fittings, and is no more than 1.5 times a pressure drop associated with the heat exchanger.

14.-16. (canceled)

17. A system, comprising:
a heat exchanger, including:
a shell having an inlet and an outlet aligned with a longitudinal axis through the shell to define a flow path through the shell along the longitudinal axis from the inlet to the outlet;
a first mandrel arranged along the longitudinal axis of the shell;
a first heat transfer surface in the shell being a plurality of first coiled tubes arranged around the first mandrel;
a second mandrel arranged along the longitudinal axis of the shell; and
a second heat transfer surface in the shell being a plurality of second coiled tubes around the second mandrel;
a feed stream in communication with the first heat transfer surface;
a heater in communication with the first heat transfer surface operable to heat the feed stream from the first heat transfer surface; and
a reactor in communication with the heater operable to output an effluent flow to the inlet of the shell, the first heat transfer surface and the second heat transfer surface operable to cool the effluent flow along the flow path.

18. The system of claim 17, wherein the first heat transfer surface and the second heat transfer surface are operable to cool the effluent flow without a substantial change in direction of the effluent flow along the flow path.

19. The system of claim 17, wherein the first transfer surface is operable to heat the feed stream against the effluent flow from the reactor, and coolant is provided to the second heat transfer surface.

20. The system of claim 17, wherein the shell includes a first portion on a first side of a plane through the shell and a second portion on a second side of the plane opposite the first side, and wherein the feed stream enters the heat exchanger in the first portion of the shell.

21.-22. (canceled)

23. The system of claim 17, wherein the effluent flow is split into a first portion and a second portion, the system further comprising:
a steam generator in communication with the reactor and operable to cool the first portion of the effluent flow,
wherein the second portion of the effluent flow bypasses the steam generator.

24. (canceled)

25. The system of claim 23, wherein the first portion and the second portion of the effluent flow are combined downstream of the steam generator and provided to the inlet of the heat exchanger.

26.-33. (canceled)

34. A system, comprising:
a heat exchanger, including:
a shell having a longitudinal axis with a first portion of the shell on a first side of a plane through the shell and a second portion of the shell on a second side of the plane opposite the first side;
one or more mandrels arranged along the longitudinal axis of the shell;
a first heat transfer surface in the first portion of the shell; and
a second heat transfer surface in the second portion of the shell;
a feed stream in communication with the first heat transfer surface;
a heater in communication with the first heat transfer surface operable to heat the feed stream output from the first heat transfer surface;
a coolant stream in communication with the second heat transfer surface;
a reactor in communication with the heater operable to output an effluent flow to the heat exchanger, the heat exchanger configured to cool the effluent flow through the shell along the longitudinal axis of the shell; and
a compressor in communication with the heat exchanger.

35. The system of claim 34, wherein cooled effluent from the heat exchanger is fed to the compressor and a pressure change between an outlet of the reactor and a suction of the compressor includes no more than 8 velocity heads associated with bends, tees, elbows or other fittings.

36. The system of claim 35, wherein the pressure change is no more than 1.5 times a pressure drop associated with the effluent flow through the heat exchanger.

37. The system of claim 34, wherein the first heat transfer surface and the second heat transfer surface are a respective plurality of coiled tubes arranged around the one or more mandrels.

38. The system of claim 34, wherein the one or more mandrels include a first mandrel extending through at least the first portion of the shell and a second mandrel extending through at least the second portion of the shell.

39. The system of claim 38, wherein the first heat transfer surface is a plurality of first tubes arranged around the first mandrel, and the second heat transfer surface is a plurality of second tubes arranged around the second mandrel.
